(19) United States
(12) Patent Application Publication
(10) Pub. No.: US 2026/0009527 A1
(43) Pub. Date: Jan. 8, 2026

(54) LIGHT STAND DEVICE

(71) Applicant: TILTA INC., Burbank, CA (US)

(72) Inventors: Sen WU, Shenzhen (CN); Wenping ZENG, Shenzhen (CN); Kefeng ZHOU, Shenzhen (CN)

(21) Appl. No.: 19/261,331

(22) Filed: Jul. 7, 2025

(30) Foreign Application Priority Data
Jul. 8, 2024 (CN) 2024216067123

(51) Int. Cl. F21V 21/30; F21V 21/008; F21V 23/04; F21V 33/00

(52) U.S. Cl. CPC F21V 21/30; F21V 21/008; F21V 23/0492; F21V 33/0052

(57) ABSTRACT

This present disclosure pertains to a light stand device, which includes a mounting bracket and a control box. The control box is equipped with a first drive assembly for controlling the horizontal rotation of the mounting bracket, and the first drive assembly is drivingly connected to the mounting bracket. The mounting bracket includes support arms and mounting assemblies for installing lighting. The support arms are provided with a second drive assembly for driving the pitch rotation of the mounting assemblies, and the second drive assembly is drivingly connected to the mounting assemblies.

### CROSS-REFERENCE TO RELATED APPLICATIONS

The present application for patent claims priority to and the benefit of pending Chinese Application No. 2024216067123, filed Jul. 8, 2024, and hereby expressly incorporated by reference herein as if fully set forth below in its entirety and for all applicable purposes.

### TECHNICAL FIELD

This disclosure pertains to the field of photographic equipment, specifically concerning a light stand.

### INTRODUCTION

During the photographic process, lights are often used in combination to achieve the desired shooting effects. The installation and support of these lights are typically accomplished through light stands. Existing light stands generally consist of two arms, with lights installed between them for support. However, these conventional light stands are unable to meet the requirements for multi-angle automatic adjustment of lighting, thereby failing to adequately satisfy the shooting needs of photographers.

For example, a shooting support frame includes a support frame body and a light source. The light source is mounted on the support frame body, which includes a vertically arranged support section, a connecting section extending horizontally from the top end of the support section, and a light box connected to the front end of the connecting section, with the light source being installed in the light box. The support frame body disclosed in this prior application exhibits the same defects as those in the existing technology mentioned above.

### BRIEF SUMMARY

To address the aforementioned issues, the technical objective of this disclosure is to provide a light stand device capable of achieving multi-angle automatic adjustment of lighting, thereby better meeting the shooting needs of photographers.

To achieve this objective, the technical solution of this disclosure is as follows:

A light stand device, including a mounting bracket and a control box; the control box is equipped with a first drive assembly for controlling the rotation of the mounting bracket relative to the control box, and the first drive assembly is drivingly connected to the mounting bracket; the mounting bracket includes support arms and mounting assemblies for installing lighting; and the support arms are provided with a second drive assembly for driving the pitch rotation of the mounting assemblies, and the second drive assembly is drivingly connected to the mounting assemblies.

### BRIEF DESCRIPTION OF THE DRAWINGS

FIG. 1 is a diagram of a light stand according to some aspects of the disclosure.

FIG. 2 is a cross-sectional view of the light stand of FIG. 1 according to some aspects of the disclosure.

FIG. 3 is an exploded view of a mounting assembly according to some aspects of the disclosure.

FIG. 4 is an exploded view of the mounting assembly and an adapter according to some aspects of the disclosure.

FIG. 5 is a diagram of the adapter according to some aspects of the disclosure.

FIG. 6 is a diagram of a locking assembly and a locking hole according to some aspects of the disclosure.

FIG. 7 is an exploded view of part of a first mounting assembly and part of a first support arm according to some aspects of the disclosure.

FIG. 8 is a diagram of a rotation surface according to some aspects of the disclosure.

FIG. 9 is an exploded view illustrating a first stroke sensor and a first limit assembly on the mounting bracket according to some aspects of the disclosure.

FIG. 10 is an exploded view of a control box according to some aspects of the disclosure.

FIG. 11 is an exploded view of the light stand and a luminaire according to some aspects of the disclosure.

### Legend:

1. mounting bracket
11. support arm; 111. first support arm; 1111. second limit track; 1112. second stroke sensor; 112. second support arm; 113. locking assembly; 1131. toggle lever; 1132. locking pin; 1133. positioning block; 1134. third elastic element; 1135. positioning lug
12. mounting assembly; 121. rotating member; 1211. first mounting position; 122. quick-release plate; 1221. third mounting position; 1222. second locking assembly; 12221. second locking lever; 12222. second locking block; 12223. second locking post; 1223. first sliding slot; 1224. second sliding slot; 123. first locking assembly; 1231. first locking lever; 1232. first locking block; 1233. first locking post; 1234. first spring; 124. adapter; 1241. limit part; 1242. positioning slot; 1243. first guide ramp; 1244. second mounting position; 12441. sliding bar; 12442. locking groove; 125. positioning assembly; 1251. release body; 1252. first protrusion; 1253. second elastic element; 1254. second protrusion; 1255. protrusion base; 1256. first elastic element; 126. release part; 1261. second guide ramp; 1262. stop surface; 127. first mounting assembly; 1271. rotation surface; 1272. second limit element; 1273. sensor element; 128. second mounting assembly; 1281. locking hole;
13. first limit assembly; 131. moving part; 132. first limit element; 133. slide slot; 134. allowance moving slot;
14. first sensor element;

2. control box; 21. first limit track; 22. first stroke sensor; 23. housing; 24. display screen; 241. control buttons; 25. cover plate; 251. lug; 26. third locking assembly; 261. latch block; 262. locking element; 263. pivot shaft; 264. second spring;

3. second drive assembly; 31. second motor; 32. second harmonic reducer; 321. second drive output;

4. first drive assembly; 41. first motor; 42. first harmonic reducer; 421. first drive output;

5. luminaire; 51. guide slot; 52. third locking lever; 53. eccentric head;

6. hanging ring.

### DETAILED DESCRIPTION

To make the objectives, technical solutions, and advantages of the present disclosure clearer, the following detailed description is provided in conjunction with the accompanying drawings and embodiments. It should be understood that the specific embodiments described herein are merely for illustrative purposes and do not limit the scope of the present disclosure.

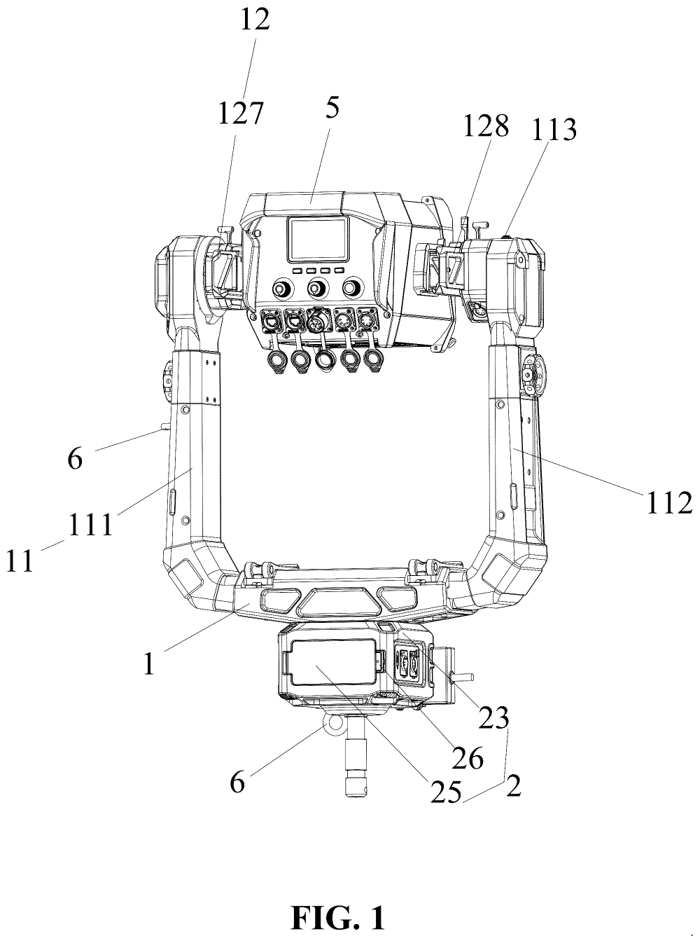

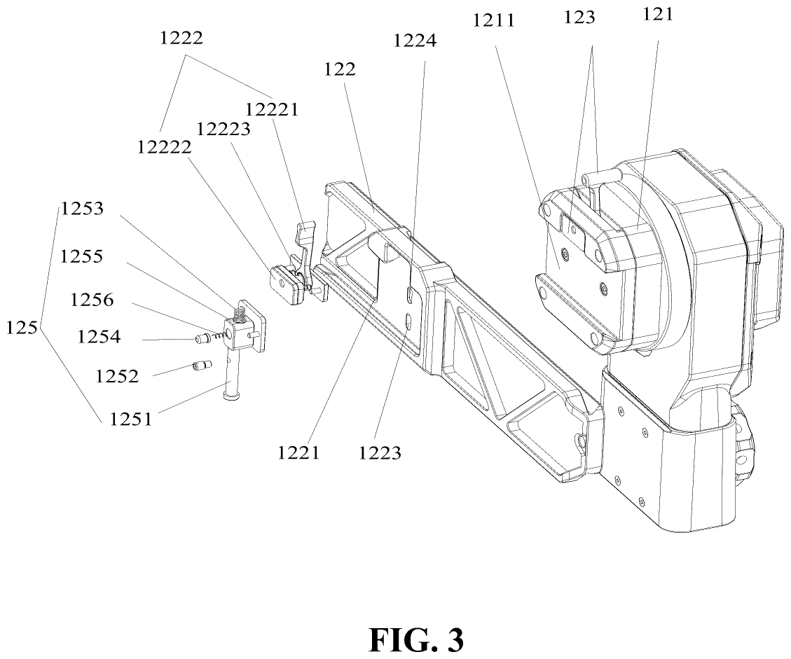

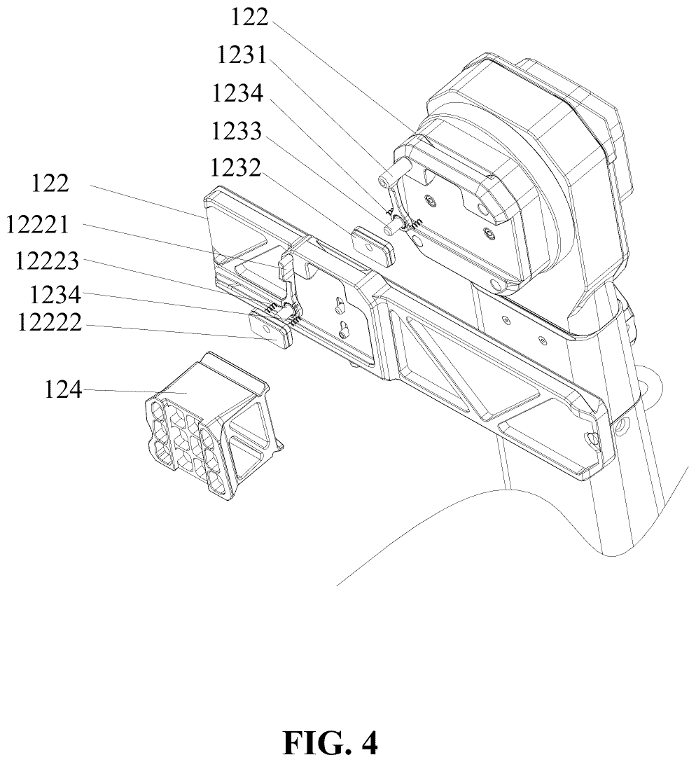

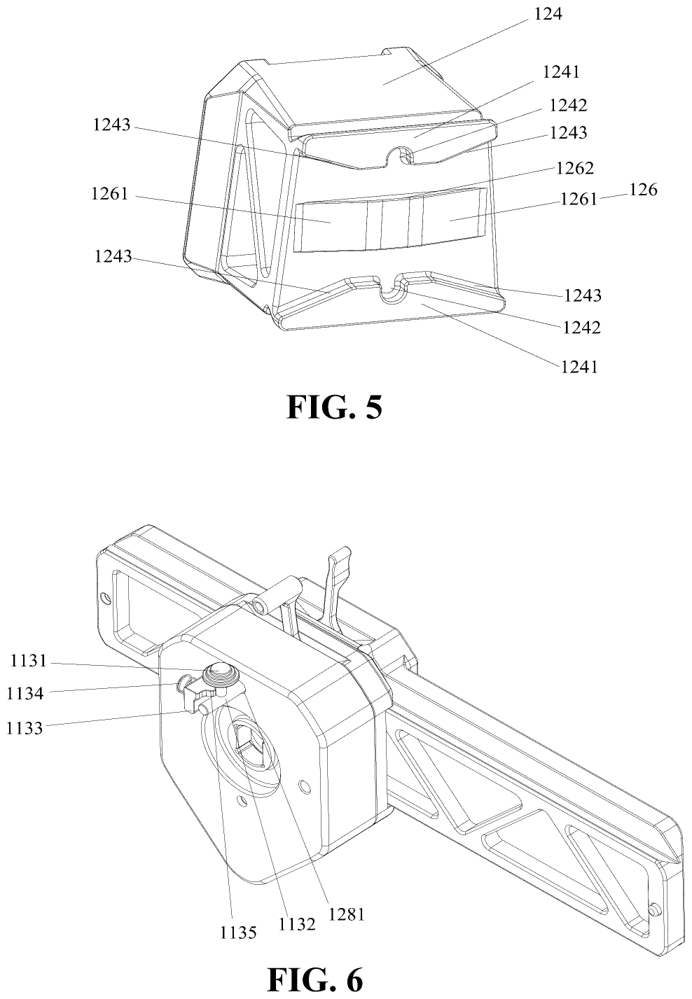

Referring to FIGS. 1-10, some aspects present a light stand device, which includes a mounting bracket 1 and a control box 2. The control box 2 is equipped with a first drive assembly 4 for controlling the horizontal rotation of the mounting bracket 1, and the first drive assembly 4 is drivingly connected to the mounting bracket 1 such that the mounting bracket 1 can be driven to rotate relative to the first drive assembly 4. The mounting bracket 1 includes support arms 11 and mounting assemblies 12 for installing a luminaire 5 (e.g., a lighting unit). The support arms 11 are provided with a second drive assembly 3 for driving the pitch rotation of the mounting assemblies 12, and the second drive assembly 3 is drivingly connected to the mounting assemblies 12. By positioning the first drive assembly 4 within the control box 2, the entire mounting bracket 1 can be driven to rotate (or pivot) horizontally on the control box 2. By placing the second drive assembly 3 on the support arms 11, the mounting assemblies 12 can be driven to rotate (or pivot) or pitch on the support arms 11, thereby controlling the pitch and horizontal angles of the luminaire 5 installed on the mounting assemblies 12.

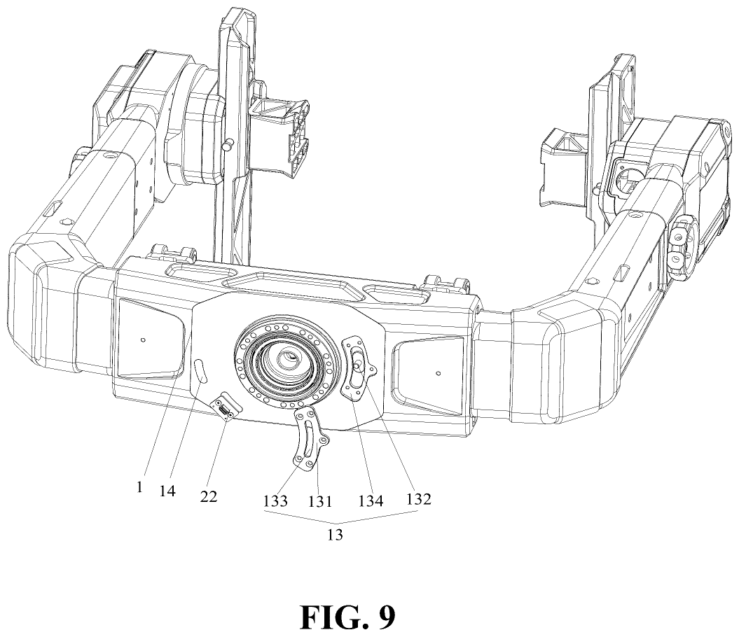

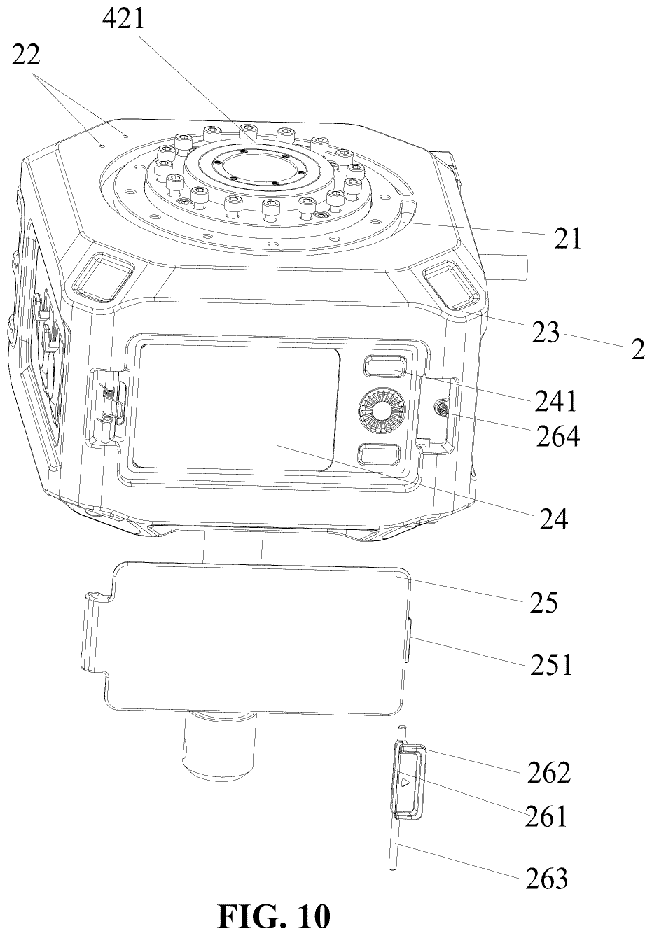

Referring to FIGS. 9-10, in some aspects, the mounting bracket 1 is provided with a first limit assembly 13, and the control box 2 is provided with a first limit track 21 corresponding to the first limit assembly 13. The first limit assembly 13 is movably disposed within the first limit track 21. When the first drive assembly 4 drives the mounting bracket 1 to rotate (or pivot) on the control box 2, the first limit assembly 13 moves synchronously within the first limit track 21, thereby limiting the horizontal rotation of the mounting bracket 1 through the cooperation of the first limit assembly 13 and the first limit track 21.

In some aspects, the mounting bracket 1 is provided with a first sensor element 14, and the control box 2 is provided with a first stroke sensor 22 for detecting the position of the first sensor element 14, with the first stroke sensor 22 being in a position corresponding to the first sensor element 14. The first stroke sensor 22 can detect the horizontal rotation stroke between the mounting bracket 1 and the control box 2 by detecting the position of the first sensor element 14. Specifically, the first sensor element 14 is a magnet, and the first stroke sensor 22 can be a Hall sensor, such as a switch-type Hall sensor. A Hall effect sensor detects magnetic fields and converts that information into an electrical signal. It's based on the Hall effect.

In some aspects, the first limit assembly 13 includes an moving part 131 and a first limit element 132. The moving part 131 is provided with a slide slot 133, and the first limit element 132 is movably disposed within the slide slot 133, with the first limit element 132 extending through the slide slot 133 into the first limit track 21.

Specifically, the mounting bracket 1 is provided with an allowance moving slot 134, and the first limit element 132 is movably disposed within the allowance moving slot 134. The moving part 131 is positioned at the allowance moving slot 134 to prevent the first limit element 132 from detaching from the allowance moving slot 134, with the first limit element 132 extending through the slide slot 133 into the first limit track 21. This arrangement ensures that the mechanical limit stroke is greater than the software limit stroke, providing an allowance (or buffer zone) when the first limit element 132 and the first limit track 21 engage in mechanical limiting, thereby ensuring the safety of the rotation process of the structure.

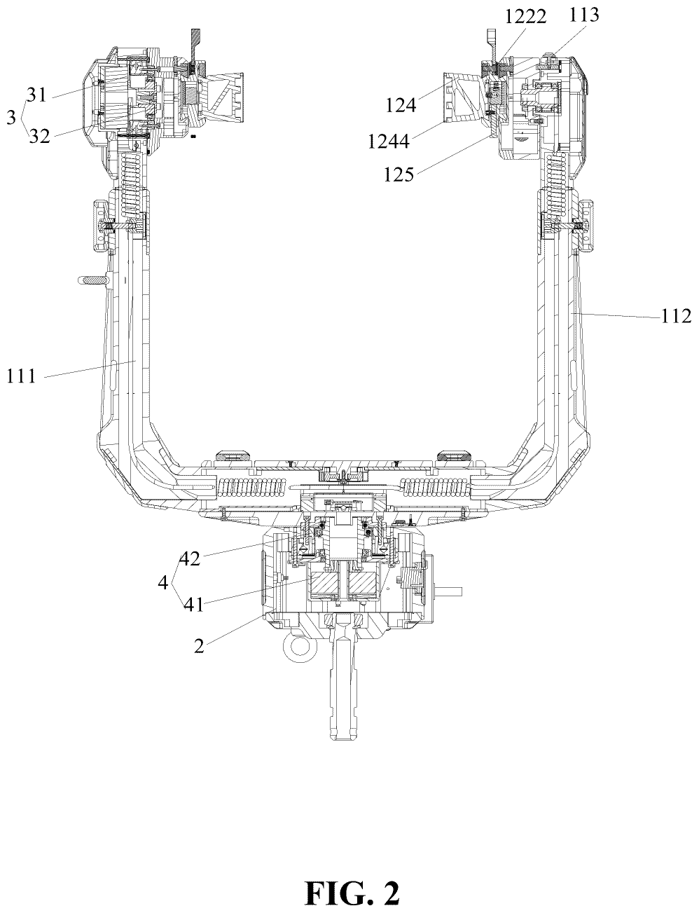

Referring to FIG. 2, in some aspects, the first drive assembly 4 includes a first motor 41 and a first harmonic reducer 42. The first motor 41 is fixedly disposed within the control box 2 and connected to the first harmonic reducer 42. The first drive output 421 of the first harmonic reducer 42 is connected to the mounting bracket 1, enabling the first motor 41 to be drivingly connected to the mounting bracket 1 through the first drive output 421 of the first harmonic reducer 42, such that the first motor 41 can drive the mounting bracket 1 to rotate.

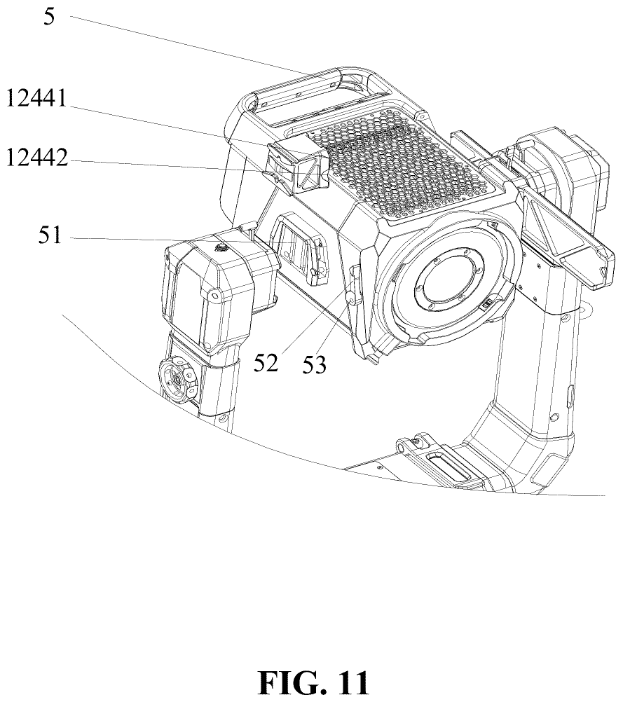

Referring to FIGS. 2-4, in some aspects, the mounting assembly 12 includes a rotating member 121, a quick-release plate 122, and an adapter 124. The rotating member 121 is provided with a first mounting position 1211, the adapter 124 is provided with a second mounting position 1244 for installing a luminaire 5 (e.g., a light unit), and the quick-release plate 122 is provided with a third mounting position 1221 for installing the adapter. In some aspects, referring to FIG. 11, the connection method between the second mounting position 1244 on the adapter 124 and the luminaire 5 can include threaded connections, sliding bar and guide slot connections, etc. Taking the sliding bar and guide slot connection as an example, the luminaire 5 in this disclosure includes a guide slot 51 disposed on the sidewall, and the mounting position 1244 in this disclosure can include a sliding bar 12441 that slides within the guide slot 51. In some aspects, the sidewall of the luminaire 5 can also include a third locking lever 52 with an eccentric head 53 for locking the sliding bar 12441. When the third locking lever 52 is actuated, the eccentric head 53 of the third locking lever 52 can move towards the guide slot 51 to lock the sliding bar 12441, thereby installing the luminaire 5. More specifically, the sliding bar 12441 is provided with a locking groove 12442, and the eccentric head 53 of the third locking lever 52 can press against the locking groove 12442.

The quick-release plate 122 is movably mounted on the first mounting position 1211, which is also equipped with a first locking assembly 123 designed to lock the quick-release plate 122 in place, with the first locking assembly 123 being positionally aligned with the quick-release plate 122. In some aspects, the quick-release plate 122 can move along the first mounting position 1211 and be secured by the first locking assembly 123 to adjust the balance of the light stand on which the luminaire 5 is mounted. It is noteworthy that the first locking assembly 123 may include a first locking lever 1231, a first locking block 1232, and a first locking post 1233, with the first locking lever 1231 connected to the first locking block 1232 via the first locking post 1233. The first mounting position 1211 can be a dovetail-shaped guide slot. The quick-release plate 122 slides within this guide slot, and when the first locking lever 1231 is locked, it drives the first locking block 1232 to firmly secure the quick-release plate 122 within the guide slot.

The quick-release plate 122 incorporates a second locking assembly 1222 for locking an adapter 124, which is detachably mounted at a third mounting position 1221, with the second locking assembly 1222 being positionally aligned with the adapter 124. The second locking assembly 1222 includes a second locking lever 12221, a second locking block 12222, and a second locking post 12223, with the second locking lever 12221 connected to the second locking block 12222 via the second locking post 12223. In some aspects, the third mounting position 1221 can be a guide slot structure with guiding functionality. After the adapter 124 slides into and is installed at the third mounting position 1221, the second locking lever 12221 controls the second locking block 12222 to press against and secure the adapter 124. In some aspects, the second locking assembly 1222 may also adopt other structures suitable for locking the adapter 124. The structures of the first locking assembly 123 and the second locking assembly 1222 can be essentially equivalent. Additionally, a first spring 1234 is disposed between the first locking block 1232 and the rotating member 121, and similarly, a first spring 1234 (another first spring) is also disposed between the second locking block 12222 and the quick-release plate 122, facilitating quick unlocking when necessary and enhancing structural stability during locking.

In some aspects, the quick-release plate 122 further incorporates a positioning assembly 125 for positioning the adapter 124 as it slides into the third mounting position 1221, with the positioning assembly 125 being positionally aligned with the adapter 124. The inclusion of this positioning assembly 125 enables precise positioning of the adapter 124 when it slides into and is installed at the third mounting position 1221.

In some aspects, the positioning assembly 125 includes a release body 1251 and a first protrusion 1252. A first sliding slot 1223 is provided at the third mounting position 1221. The release body 1251 is movably mounted within the quick-release plate 122, with its end extending out of the quick-release plate 122. The first protrusion 1252 is fixedly mounted on the side of the release body 1251 and is movably disposed at the first sliding slot 1223, with its end extending out of the first sliding slot 1223 and into the third mounting position 1221. The adapter 124 is equipped with a limit part 1241, which has a positioning slot 1242 and a first guide ramp 1243 for guiding the first protrusion 1252 to move along the first sliding slot 1223. The positioning slot 1242 and the first guide ramp 1243 are connected, allowing the end of the first protrusion 1252 to move into the positioning slot 1242 along the first guide ramp 1243 to enhance structural stability.

In some aspects, the positioning assembly 125 includes a second protrusion 1254, a protrusion base 1255, and a first elastic element 1256, with the first elastic element 1256 disposed between the second protrusion 1254 and the protrusion base 1255, and the protrusion base 1255 connected to the release body 1251. A second sliding slot 1224 is provided at the third mounting position 1221. The second protrusion 1254 is movably mounted at the second sliding slot 1224, with its end extending out of the second sliding slot 1224 and into the third mounting position 1221. The adapter 124 further includes a release part 126, which has a second guide ramp 1261 for guiding the second protrusion 1254 to move up and down within the second sliding slot 1224. A stop surface 1262 is provided beside the second guide ramp 1261 on the release part 126 to block the second protrusion 1254. In this configuration, when disassembling the luminaire 5, the release part 126 can be pressed down, and the stop surface 1262 limits the second protrusion 1254, keeping the first protrusion 1252 in a state of being away from the positioning slot 1242. Thus, the user can release the release part 126 for further disassembly, facilitating the user's operation.

In some aspects, the positioning assembly 125 further includes a second elastic element 1253, which is disposed within the quick-release plate 122 and connected to the protrusion base 1255. This second elastic element 1253 is used to reset the positioning assembly 125 after the release body 1251 is pressed.

When the adapter 124 slides into the third mounting position 1221, the first protrusion 1252 moves against the first guide ramp 1243 and along the first sliding slot 1223 under its guidance, and is positioned when it moves into the positioning slot 1242. Simultaneously, the second protrusion 1254 moves against the second guide ramp 1261, gradually compressing the first elastic element 1256 and descending within the second sliding slot 1224.

When the adapter 124 needs to be removed from the third mounting position 1221, the release body 1251 is pressed, causing it to move the first protrusion 1252 and the second protrusion 1254. The first protrusion 1252 disengages from the positioning slot 1242, and the second protrusion 1254 disengages from the second guide ramp 1261. At this time, the second protrusion 1254 extends out of the second sliding slot 1224 under the action of the first elastic element 1256 and abuts against the stop surface 1262, preventing the positioning assembly 125 from resetting directly, thus keeping the first protrusion 1252 in a state of being away from the positioning slot 1242. Then, the adapter 124 can be slid out. After the adapter 124 is removed, the positioning assembly 125 resets under the action of the second elastic element 1253.

Referring to FIGS. 1-2, in some aspects, the mounting bracket 1 includes two or more support arms 11 and two or more mounting assemblies 12. In one example, the two or more support arms 11 include a first support arm 111 and a second support arm 112. The second drive assembly 3 is disposed within the first support arm 111. In one example, the two or more mounting assemblies 12 include a first mounting assembly 127 and a second mounting assembly 128. The second drive assembly 3 is drivingly connected to the first mounting assembly 127. The second mounting assembly 128 is rotatably and movably mounted on the second support arm 112, with the first mounting assembly 127 and the second mounting assembly 128 being positionally aligned. The luminaire 5 is connected to both the first mounting assembly 127 and the second mounting assembly 128 to be supported by the first support arm 111 and the second support arm 112. When adjusting the pitch of the luminaire 5, the second drive assembly 3 within the first support arm 111 drives the first mounting assembly 127 to rotate (or pivot) the luminaire 5 for pitch adjustment. Simultaneously, the second support arm 112 and the second mounting assembly 128 connected to the luminaire 5 rotate (or pivot) synchronously for pitch adjustment, effectively ensuring the stability of the luminaire 5 during pitch adjustment.

Referring to FIG. 6, in some aspects, the second support arm 112 (see FIG. 2) is equipped with a locking assembly 113 (see FIG. 2) designed to lock or unlock the second mounting assembly 128, and the locking assembly 113 is positioned to correspond with the second mounting assembly 128. The inclusion of the locking assembly 113 enables the locking or unlocking of the position of the second mounting assembly 128. When it is necessary to adjust the pitch angle of the luminaire 5, the second mounting assembly 128 can be unlocked, allowing for rotational adjustment of the luminaire's pitch angle.

In some aspects, the locking assembly 113 includes a toggle lever 1131 and a locking pin 1132. The second mounting assembly 128 is provided with a locking hole 1281 that corresponds to the locking pin 1132, with the end of the locking pin 1132 aligned with the locking hole 1281. The toggle lever 1131 is connected to the side of the locking pin 1132 and is movably connected to the second support arm 112, with the end of the toggle lever 1131 away from the locking pin 1132 extending through the second support arm 112 and being externally exposed. In some aspects, the toggle lever 1131 controls the movement of the locking pin 1132 to engage or disengage from the locking hole 1281, thereby locking or unlocking the second mounting assembly 128.

In some aspects, the locking assembly 113 further includes a positioning block 1133 and a third elastic element 1134. The positioning block 1133 is provided with a positioning lug 1135 that resiliently abuts against the side of the toggle lever 1131. The third clastic element 1134 is disposed on the side of the positioning block 1133 opposite to the positioning lug 1135. The positioning lug 1135 is generally triangular in shape, with its two sides corresponding to the states where the locking pin 1132 engages with and disengages from the locking hole 1281, respectively. In some aspects, when the toggle lever 1131 is toggled, it compresses the third elastic element 1134 by abutting against the positioning lug 1135 and simultaneously toggles from one side of the positioning lug 1135 to the other. The third elastic element 1134 then resets the positioning lug 1135 to engage with the toggle lever 1131, thereby achieving state switching of the locking pin 1132.

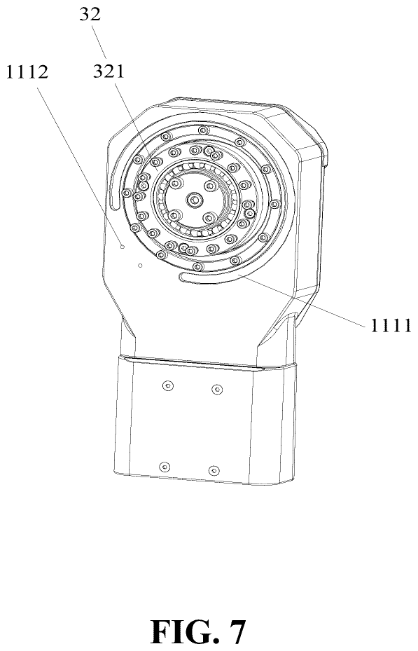

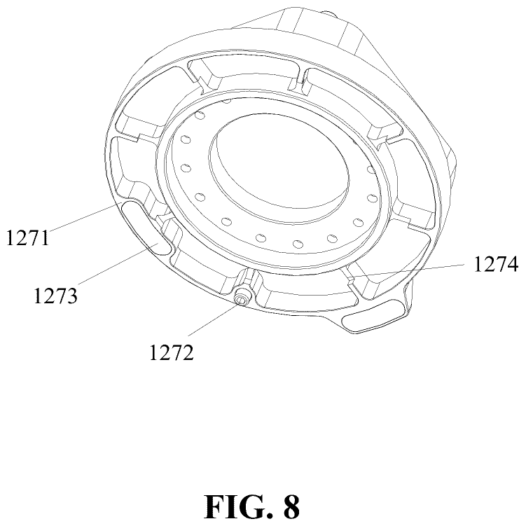

Referring to FIGS. 7-8, in some aspects, the first mounting assembly 127 is provided with a rotation surface 1271, and the second drive assembly 3 is drivingly connected to the rotation surface 1271.

In some aspects, the rotation surface 1271 is provided with a second limit element 1272. The first support arm 111 is provided with a second limit track 1111 that corresponds to the second limit element 1272, and the second limit element 1272 is slidably disposed within the second limit track 1111. The inclusion of the second limit track 1111 ensures that when the second drive assembly 3 drives the first mounting assembly 127 to pitch and rotate, the second limit element 1272 moves within the second limit track 1111, thereby limiting the pitch and rotation range of the first mounting assembly 127 through the cooperation between the second limit element 1272 and the second limit track 1111.

In some aspects, the rotation surface 1271 is provided with a second sensor element 1273, and the first support arm 111 is provided with a second stroke sensor 1112 for detecting the position of the second sensor element 1273, with the second stroke sensor 1112 positioned to correspond with the second sensor element 1273. The second stroke sensor 1112 detects the pitch and rotation stroke by detecting the position of the second sensor element 1273. This setup enables safety detection of the rotational stroke and incorporates software limiting. Specifically, the mechanical limiting angle provided by the second limit element 1272 and the second limit track 1111 may be slightly larger than the software limiting angle to provide a mechanical allowance, thereby ensuring the operational safety of the structure. In one example, the second sensor element 1273 is a magnet, and the second stroke sensor 1112 is a Hall sensor, such as a switch-type Hall sensor. It should be noted that the pitch stroke limited by the second limit track 1111 is greater than the stroke specified by the software, thereby providing a tolerance for the rotation of the light stand device to ensure its safety during rotation. Furthermore, the additional tolerance stroke of the second limit track 1111 can be distributed at both ends of the second limit track 1111 to provide a tolerance at both the origin and the endpoint of the pitch and rotation of the luminaire 5.

In some aspects, the second drive assembly 3 includes a second motor 31 and a second harmonic reducer 32. The second motor 31 is fixedly connected to the first support arm 111 and is connected to the second harmonic reducer 32. The second drive output 321 of the second harmonic reducer 32 is connected to the rotation surface 1271, enabling the second motor 31 to be drivingly connected to the rotation surface 1271 through the second drive output 321 of the second harmonic reducer 32.

In some aspects, both the mounting bracket 1 and the control box 2 are provided with hanging rings 6. In this context, the light stand device can be mounted on a fixed support on the ground. In some usage scenarios, the light stand device can also be installed in a suspended manner. The hanging rings 6 can assist in the suspended installation, for example, by using hanging ropes passed through the hanging rings 6 to help suspend the light stand device.

Referring to FIGS. 1 and 10, in some aspects, the control box 2 includes a housing 23, a display screen 24, a cover plate 25, and a third locking assembly 26. The display screen 24 is fixedly disposed on the housing 23, and the cover plate 25 is slidably disposed on the housing 23. The cover plate 25 is provided with a lug 251. The third locking assembly 26 includes a locking element 262 with a latch block 261 and a pivot shaft 263. The latch block 261 can engage with the lug 251, and the locking element 262 is pivotally disposed on the housing 23 through the pivot shaft 263. When the locking element 262 is pressed to disengage the latch block 261 from the lug 251, the user can flip the cover plate 25 to observe the electronic control data displayed on the display screen 24, such as the pitch angle. The user can also reset the cover plate 25 and press the locking element 262 to rotate it. After the cover plate 25 is reset, the latch block 261 can press against the lug 251 to cover the display screen 24 for protection. It should be noted that a second spring 264 can also be provided between the locking element 262 and the housing 23 to increase structural stability and provide elastic force for resetting the locking element 262. Additionally, control buttons 241 for controlling the information displayed on the display screen 24 can also be provided on the display screen 24.

The above descriptions represent exemplary embodiments of the present disclosure and should not be construed as limiting the scope of the present disclosure. Any modifications, equivalent substitutions, and improvements made within the spirit and principles of the present disclosure shall fall within the protection scope of the present disclosure.

As used in the claims, the indefinite articles “a” and “an” should be understood to mean “one or more” unless explicitly stated otherwise or unless the context clearly dictates a singular interpretation. The use of these articles does not limit the claimed invention to a single instance of the referenced element but rather encompasses multiple instances where applicable.

What is claimed is:

1. A light stand device, comprising:
a mounting bracket; and
a control box;
wherein, the control box is provided with a first driving assembly configured to drive the mounting bracket to rotate relative to the control box, and the first drive assembly is drivingly connected to the mounting bracket;
wherein the mounting bracket comprises a support arm and a mounting assembly configured to install a luminaire; and
wherein a second drive assembly is provided at the support arm configured to drive the mounting assembly to perform pitch rotation, and the second drive assembly is drivingly connected to the mounting assembly.

2. The light stand device according to claim 1, wherein a first limit assembly is provided on the mounting bracket, and a first limit track is provided on the control box corresponding to the first limit assembly, and the first limit assembly being movably provided within the first limit track.

3. The light stand device according to claim 1, wherein, a first limit assembly is provided on the control box, and a first limit track is provided on the mounting bracket corresponding to the first limit assembly, and the first limit assembly being movably provided within the first limit track.

4. The light stand device according to claim 3, wherein a first sensor element is provided on the mounting bracket, and the control box is provided with a first stroke sensor configured to detect positions of the first sensor element.

5. The light stand device according to claim 3, wherein a first sensor element is provided on the control box, and the mounting bracket is provided with a first stroke sensor configured to detect positions of the first sensor element.

6. The light stand device according to claim 3, wherein the first limit assembly comprises a moving part and a first limit element; and
wherein a slide slot is provided on the moving part, and the first limit element is movably provided at the slide slot, and the first limit element extending through the slide slot into the first limit track.

7. The light stand device according to claim 1, wherein a rotation surface is provided on the mounting assembly, the second drive assembly is drivingly connected to the rotation surface;
wherein a second limit element is provided on the rotation surface, and a second limit track is provided on the support arm corresponding to the second limit element, the second limit element being movably provided within the second limit track.

8. The light stand device according to claim 1, wherein a rotation surface is provided on the mounting assembly, the second drive assembly is drivingly connected to the rotation surface;
wherein a second limit element is provided on the support arm, and a second limit track is provided on the rotation surface corresponding to the second limit element, the second limit element being movably provided within the second limit track.

9. The light stand device according to claim 8, wherein a second sensor element is provided on the rotation surface, and a second stroke sensor is provided on the support arm configured to detect positions of the second sensor element, the second stroke sensor corresponding in position to the second sensor element.

10. The light stand device according to claim 1, wherein the mounting assembly comprises a rotating member and a mounting member;
wherein a first mounting position is provided on the rotating member, and the mounting member is provided with a second mounting position configured to install the luminaire; and
wherein the mounting member is movably provided on the first mounting position, and the first position is provided with a first locking assembly configured to lock the mounting member,
the first locking assembly corresponding in position to the mounting member.

11. The light stand device according to claim 10, wherein the mounting member comprises a quick-release plate and an adapter;
wherein the quick-release plate is movably provided on the first mounting position, and the second mounting position is located on the adapter;
wherein the quick-release plate comprises a third mounting position, and the quick-release plate is provided with a second locking assembly configured to lock the adapter; and
wherein the adapter is detachably provided at the third mounting position.

12. The light stand device according to claim 11, wherein the quick-release plate is provided with a positioning assembly configured to position the adapter sliding into the third mounting position, the positioning assembly corresponding to the adapter;
wherein the positioning assembly comprises a release body and a first protrusion;
wherein a first sliding slot is provided at the third mounting position, and the release body is movably provided inside the quick-release plate, and an end of the release body extending through the quick-release plate and being exposed externally;
wherein the first protrusion is provided on one side of the release body, and one end of the first protrusion extending through the first sliding slot and being exposed at the third mounting position, the first protrusion being able to move within the first sliding slot;
wherein the adapter is provided with a limit part, and a positioning slot and a first guide ramp are provided on the limit part, the positioning slot and the first guide ramp being connected; and
wherein one end of the first protrusion is configured to move along the first guide ramp into the positioning slot.

13. The light stand device according to claim 9, wherein the positioning assembly further comprises a second protrusion, a protrusion base, and a first elastic element;
wherein the first elastic element is provided between the second protrusion and the protrusion base, the protrusion base being connected to the release body;
wherein a second sliding slot is provided at the third mounting position, and the second protrusion is configured to move within the second sliding slot; and
wherein the adapter comprises a release part and a second guide ramp is provided on the release part, and the release part beside the second guide ramp is provided on a stop surface.

14. The light stand device according to claim 1, wherein a hanging ring is provided on the mounting bracket and the control box.

15. The light stand device according to claim 1, wherein a hanging ring is provided on the mounting bracket or the control box.

16. The light stand device according to claim 1, wherein the mounting bracket comprises two or more support arms and two or more mounting assemblies;
wherein the two or more support arms comprise a first support arm and a second support arm, the second drive assembly being provided inside the first support arm;
wherein the two or more mounting assemblies comprise a first mounting assembly and a second mounting assembly;
wherein the second drive assembly is drivingly connected to the first mounting assembly, and the second mounting assembly is rotatably and movably provided on the second support arm; and
wherein the luminaire is configured to be between the first mounting assembly and the second mounting assembly.

17. The light stand device according to claim 16, wherein a locking assembly for locking or unlocking the second mounting assembly is provided on the second support arm;
wherein the locking assembly comprises a toggle lever, a locking pin, a positioning block, and a third elastic element;
wherein a locking hole corresponding to the locking pin is provided on the second mounting assembly, one end of the locking pin corresponding to the locking hole;
wherein the toggle lever is connected to one side of the locking pin and is movably connected to the support arm, one end of the toggle lever away from the locking pin extending through the support arm and being exposed externally;
wherein a positioning lug is provided on the positioning block, the positioning lug being movably in contact with one side of the toggle lever; and
wherein the third elastic element is provided on one side of the positioning block away from the positioning lug.

18. The light stand device according to claim 1, wherein the control box comprises a housing, a display screen, and a cover plate; and
wherein both the display screen and the cover plate are provided at the housing, and the cover plate is configured to cover or expose the display screen in response to a movement of the cover plate.

19. The light stand device according to claim 18, wherein a third locking assembly is provided on the control box; and
wherein the cover plate is provided with a lug, and the third locking assembly is movably provided on the housing and is configured to lock the lug.
